(19) United States
(12) Patent Application Publication
(10) Pub. No.: US 2021/0152761 A1
(43) Pub. Date: May 20, 2021

(54) ELECTRONIC DEVICE AND METHOD FOR CONTROLLING THE SAME

(71) Applicant: Samsung Electronics Co., Ltd., Gyeonggi-do (KR)

(72) Inventors: Dongsoo Kim, Gyeonggi-do (KR); Kawang Kang, Gyeonggi-do (KR); Hwayoung Kang, Gyeonggi-do (KR); Yeongeun Kim, Gyeonggi-do (KR); Yeotak Youn, Gyeonggi-do (KR)

(21) Appl. No.: 17/097,588

(22) Filed: Nov. 13, 2020

(30) Foreign Application Priority Data
Nov. 14, 2019 (KR) 10-2019-0145669

(51) Int. Cl. H04N 5/345

(52) U.S. Cl. CPC H04N 5/3454

(57) ABSTRACT

Methods and apparatuses are provided in which a first image frame is obtained by exposing and reading out a first plurality of pixels corresponding to a first region of interest (ROI) via a first image sensor. While the first image frame is being obtained, a control signal is obtained for changing the first ROI to a second ROI based on an image frame obtained from the second image sensor. In response to the obtained control signal, a second image frame continuous from the first image frame is obtained by exposing and reading out a second plurality of pixels corresponding to the second ROI via the first image sensor.

### CROSS-REFERENCE TO RELATED APPLICATION(S)

This application is based on and claims priority under 35 U.S.C. 119(a) to Korean Patent Application No. 10-2019-0145669, filed on Nov. 14, 2019 in the Korean Intellectual Property Office, the disclosure of which is incorporated herein by reference in its entirety.

### BACKGROUND

### 1. Field

Embodiments of the disclosure relate generally to an electronic device, and more particularly, to an electronic device including an image sensor with a zooming function and a method for controlling the same.

### 2. Description of Related Art

Developing electronic devices provide more diversified services and additional functions. Various applications are being developed to meet the demand of diverse users and to raise the utility of electronic devices upon which they are executed.

A camera application allows a user to take a selfie or background, or to record a video, using the camera equipped in the electronic device. Thus, the electronic device may include an image sensor for capturing images or videos. The image sensor typically includes a lens for collecting light, a photodiode for converting the collected light into an electrical signal, and an analog-to-digital converter (ADC) for converting the electrical signal, which is an analog signal, into a digital electrical signal. A shutter typically exposes a plurality of photodiodes to light by the image sensor, and the process of converting electrical signals from multiple photodiodes into digital electrical signals and outputting the digital electrical signals may be referred to as “read-out.”

Electronic devices with multiple image sensors are being released. Simultaneously storing videos obtained by several image sensors consumes a large amount of power, causing a limit to the use time.

Upon obtaining an enlarged (e.g., zoomed-in) image of a specific object from one of the plurality of image sensors, the electronic device may require excessive power and resource consumption because the position of the area to be enlarged must be changed in real-time due to the movement of the object.

### SUMMARY

According to an embodiment of the disclosure, an electronic device is provided that includes an image sensor that is capable of reading only a specific area from the image sensor and, even when the position of the specific area is changed, outputting the image frames with constant intervals, and a method for controlling the same.

In accordance with an embodiment, an electronic device is provided that includes a first image sensor and a second image sensor. The first image sensor is configured to obtain a first image frame by exposing and reading out a first plurality of pixels corresponding to a first region of interest (ROI). The first image sensor is also configured to, in response to a control signal for changing the first ROI to a second ROI, obtain a second image frame continuous from the first image frame by exposing and reading out a second plurality of pixels corresponding to the second ROI. The second ROI is obtained based on an image frame obtained from the second image sensor, and the control signal is input while the first image frame is being obtained. In accordance with an embodiment, a method is provided for controlling an electronic device. A first image frame is obtained by exposing and reading out a first plurality of pixels corresponding to a first ROI via a first image sensor. While the first image frame is being obtained, a control signal is obtained for changing the first ROI to a second ROI based on an image frame obtained from the second image sensor. In response to the obtained control signal, a second image frame continuous from the first image frame is obtained by exposing and reading out a second plurality of pixels corresponding to the second ROI via the first image sensor.

In accordance with an embodiment, an image sensor is provided that includes a plurality of pixels and a controller. The controller is configured to obtain a first image frame by exposing and reading out a first plurality of pixels corresponding to a first ROI among the plurality of pixels. In response to a control signal for changing the first ROI to a second ROI, the controller is also configured to obtain a second image frame continuous from the first image frame by exposing and reading out a second plurality of pixels corresponding to the second ROI. The control signal is input while the first image frame is being obtained.

### BRIEF DESCRIPTION OF THE DRAWINGS

The above and other aspects, features, and advantages of the disclosure will be more apparent from the following detailed description when taken in conjunction with the accompanying drawings, in which:

FIG. 1 is a block diagram illustrating an electronic device in a network environment according to an embodiment;

FIG. 2 is a block diagram illustrating an electronic device capable of performing a zoom function, according to an embodiment;

FIG. 3 is a block diagram illustrating a structure of an image sensor, according to an embodiment;

FIG. 4 is a flowchart illustrating operations of an electronic device performing a zoom function, according to an embodiment;

FIG. 5 is a diagram illustrating operations of an electronic device performing a zoom function using a plurality of image sensors, according to an embodiment;

FIG. 6 is a block diagram illustrating the operation of providing an ROI change control signal to an image sensor by a processor of an electronic device, according to an embodiment;

FIG. 7 is a block diagram illustrating the operation of providing an ROI change control signal to another image sensor by an image sensor, according to an embodiment;

FIG. 8 is a block diagram illustrating operations of an image sensor when a control signal for changing the ROI is input, according to an embodiment;

FIG. 9 is a diagram illustrating a read-out operation of an electronic device according to an embodiment;

FIG. 10 is a diagram illustrating a read-out operation of an electronic device considering correction, according to an embodiment;

FIGS. 11A and 11B are diagrams illustrating operations of an electronic device when the ROI is changed as an obtained image is repositioned, according to an embodiment;

FIGS. 12A and 12B are diagrams illustrating operations of an electronic device when the ROI is changed by a user's selection, according to an embodiment; and

FIGS. 13A and 13B are diagrams illustrating operations of an electronic device when a user selects a zoomed image, according to an embodiment.

### DETAILED DESCRIPTION

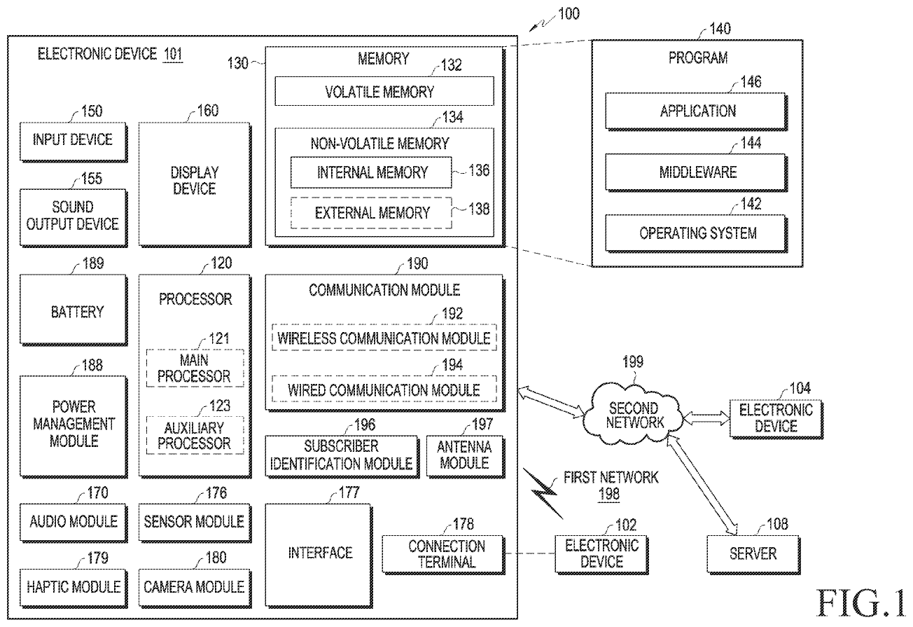

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device). According to an embodiment, the antenna module may include one antenna including a radiator formed of a conductor or conductive pattern formed on a substrate (e.g., a printed circuit board (PCB)). According to an embodiment, the antenna module 197 may include a plurality of antennas. In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

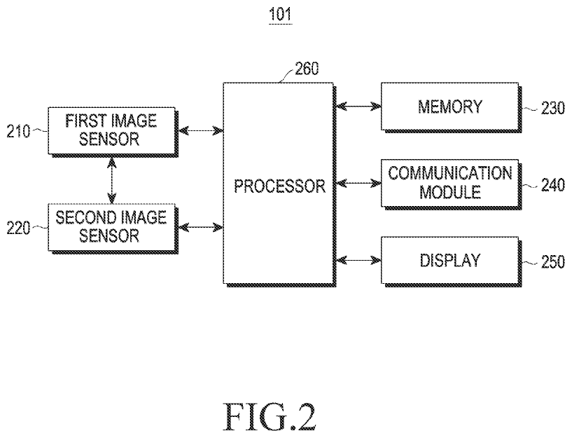

FIG. 2 is a block diagram illustrating an electronic device capable of performing a zoom function, according to an embodiment.

An electronic device 101 includes at least a first image sensor 210, a second image sensor 220, a memory 230, a communication module 240, a display 250, and a processor 260.

According to an embodiment, the first image sensor 210 may expose a first plurality of pixels corresponding to a first ROI, read out, and obtain a first image frame. For example, the first image sensor 210 may expose the first plurality of pixels corresponding to the first ROI, read out, and generate the first image frame. The ROI is an area of interest and a partial area that the user is interested in of the entire image frame that may be obtained from the image sensor.

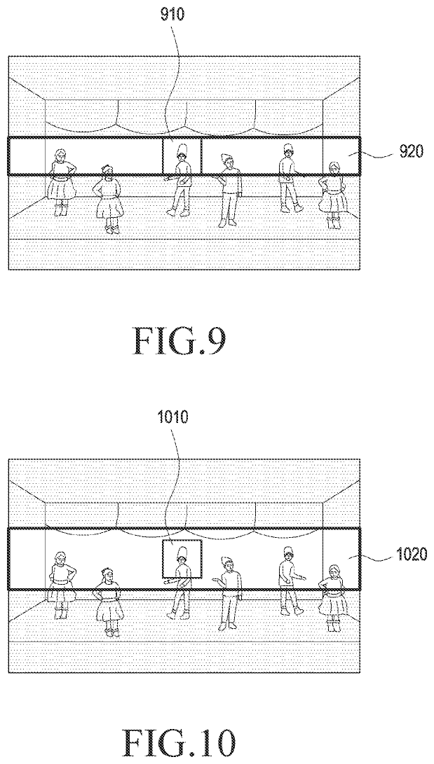

The first image sensor 210 obtains the image frame by exposing and reading out only pixels corresponding to the first ROI, thereby reducing power and resource consumption. For example, the first image sensor 210 may expose the pixels in a rolling shutter manner. To obtain the image frame of the first ROI, the first image sensor 210 may sequentially expose, row-by-row, the pixels in the rows in which the first ROI is included, which is described in greater detail below with reference to FIG. 9.

The first ROI may be an area including a center portion of the image frame that may be obtained by the first image sensor 210, or may be an area that is selected by the user of the image frame obtainable by the first image sensor 210. The electronic device 101 may display an image frame with a broad angle of view, obtained from the second image sensor 220, on the display 250 and, when the user selects an ROI (e.g., an object, a specific person, or a specific thing), may identify, as a first ROI, a region corresponding to a region selected from an image frame obtainable by the first image sensor 210. The size of the first ROI may be varied depending on the resolution of the first image sensor 210.

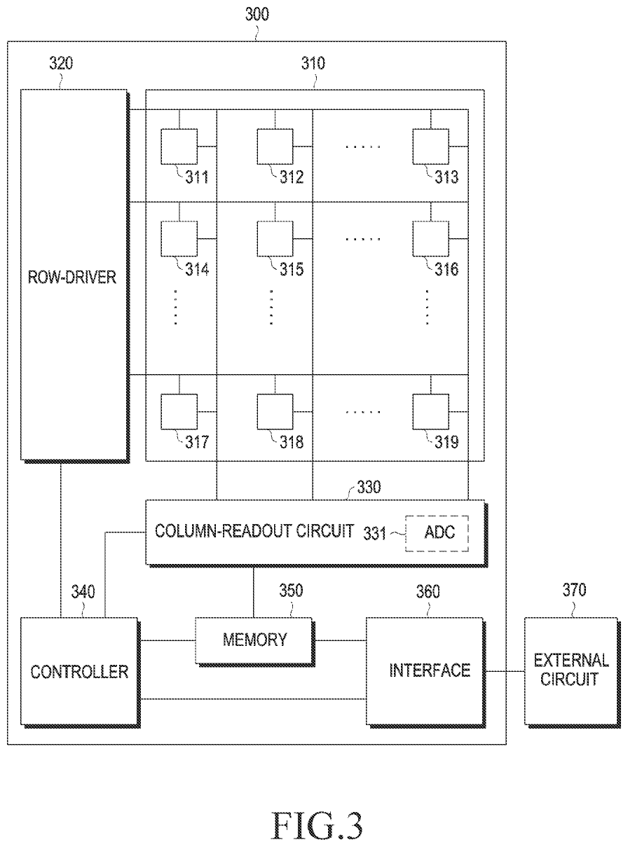

When a control signal for changing the first ROI to a second ROI, obtained based on an image frame obtained from the second image sensor 220, is input while the first image frame is obtained, the first image sensor 210 may obtain a second image frame continuous from the first image frame by exposing and reading out a second plurality of pixels corresponding to the second ROI. A specific configuration of the first image sensor 210 and the second image sensor 220 is described in greater detail below with reference to FIG. 3.

The first ROI may correspond to a first region including a first object of the image frame obtained from the second image sensor 220.

When at least one of the position and size of the first region is changed, the second image sensor 220 may obtain a control signal for changing the first ROI to the second ROI corresponding to the changed first region, based on at least one of position information and size information about the changed first region, and may input the obtained control signal to the first image sensor 210. For example, the second image sensor 220 may generate a control signal for changing the first ROI to the second ROI corresponding to the changed first region, based on at least one of the position information and size information about the changed first region. When the position or size of a first object in the image frame obtained from the second image sensor 220 is changed, the second image sensor 220 may obtain coordinate information or size information about the region including the position- or size-changed first object, and may obtain a control signal for changing the first ROI to the second RO based on the obtained coordinate information and size information.

When at least one of the position and size of the first region is changed, the processor 260 may obtain a control signal for changing the first ROI to the second ROI corresponding to the changed first region, based on at least one of position information and size information about the changed first region, and may input the obtained control signal to the first image sensor 210.

When the obtained control signal is input to the first image sensor 210 while the first plurality of pixels are exposed, the first image sensor 210 may start to read out the first plurality of pixels corresponding to the first ROI, and then start to expose the second plurality of pixels corresponding to the second ROI. For example, the first image sensor 210 may receive a control signal from the second image sensor 220 or the processor 260. When the obtained control signal is input to the first image sensor 210 while the first plurality of pixels are exposed, it may be preferable to simultaneously perform the start of the read-out of the first plurality of pixels corresponding to the first ROI and the start of the exposure of the second plurality of pixels corresponding to the second ROI. However, an inevitable delay may intervene between the start time of the read-out of the first plurality of pixels and the start time of the exposure of the second plurality of pixels. As such, since the exposure of the second plurality of pixels starts as the read-out of the first plurality of pixels starts, although the region where the pixel signal is to be read out is changed from the first ROI to the second ROI, the output interval between the image frames may remain constant.

The first image frame obtained from the first image sensor 210, the second image frame, and the image frame obtained from the second image sensor 220 may be stored in the memory 230. Thus, video with a broad angle of view and video with a narrow angle of view both may be obtained.

The processor 260 may perform image stabilization on the image frame obtained from the first image sensor 210, and may store the corrected ROI image frame in the memory 230. The size of the corrected ROI image frame may be smaller than the size of at least one of the first ROI or the second ROI. For example, the first image sensor 210 may obtain an image frame larger in size than the first ROI or the second ROI, and the processor 260 may perform image stabilization on the obtained image frame and store the resultant image in the memory 230, which is described in greater detail below with reference to FIG. 10.

The angle of view of the image frame obtained from the second image sensor 220 may be larger than the angle of view of the image frame obtained from the first image sensor 210. It is for this reason that the image frame obtained from the first image sensor 210 is an area or portion of the image frame obtained from the second image sensor 220. In practice, the angle of view of the entire image frame obtainable by the first image sensor 210 may be equal to or larger than the angle of view of the entire image frame obtainable by the second image sensor 220.

The resolution of the first image sensor 210 may be higher than the resolution of the second image sensor 220.

The control signal may include coordinate information about at least two of the second plurality of pixels corresponding to the second ROI, or coordinate information about at least one of the second plurality of pixels, and size information about the second ROI. For example, the control signal for changing the ROI may include the coordinates of two diagonal vertices of the four vertices of the ROI, and the coordinates of one the vertex and the center. The control signal for changing the ROI may include the coordinates of one of the four vertices of the ROI and size information about the ROI. The control signal for changing the ROI may include variations in position and variations in size, based on information about the first ROI.

The processor 260 may display at least one of the first image frame obtained from the first image sensor 210, the second image frame, and the image frame obtained from the second image sensor 220, on the display 250. In this case, the processor 260 may include a plurality of SPs, and the image sensors 210 and 220, respectively, may correspond to ISP channels. The processor 260 may process the image frame received from each image sensor 210 and 220 via the corresponding ISP channel, and may display the processed result on the display 250 or store the processed result in the memory 230.

The processor 260 may display the image frame obtained from the second image sensor 220 on the entire screen of the display 250, and may display the image frame obtained from the first image sensor 210 in a partial area of the display 250, in a picture-in-picture (PIP) fashion. The processor 260 may split the screen of the display 250 into one area for displaying the image frame obtained from the second image sensor 220 and another area for displaying the image frame obtained from the first image sensor 210.

When the user selects one image frame, with the image frame obtained from the second image sensor 220 and the image frame obtained from the first image sensor 210 displayed on the display 250, the electronic device 101 may display the selected image on the entire screen of the display 250.

The electronic device 101 may not include the display 250. For example, the electronic device 101 may transmit the image frame obtained from the first image sensor 210 and the image frame obtained from the second image sensor 220 to an external device via the communication module 240.

Although an example is described above in which the ROI of the first image sensor 210 is changed based on the image frame obtained from the second image sensor 220, the electronic device 101 may include only the first image sensor 210, according to an embodiment. For example, the electronic device 101 may receive a control signal for changing the ROI from an external device via the communication module 240, obtain a control signal for changing the ROI in the electronic device 101, based on object movement information received from an external device, or obtain a control signal for changing the ROI, based on object movement information obtained via a sensor, other than the image sensors equipped in the electronic device 101.

FIG. 3 is a block diagram illustrating a structure of an image sensor, according to an embodiment.

An image sensor 300 may be one of the first image sensor 210 and the second image sensor 220 of FIG. 2, which is a component of the camera module 180 provided in the electronic device 101 of FIG. 1.

Referring to FIG. 3, the image sensor 300 includes at least a pixel array 310, a row-driver 320, a column-readout circuit 330, a controller 340, a memory 350, and an interface 360.

The pixel array 310 includes a plurality of pixels 311 to 319. For example, the pixel array 310 may have a structure in which the plurality of pixels 311 to 319 are arrayed in an M×N matrix pattern (where M and N are positive integers). The pixel array 310, in which the plurality of pixels 311 to 319 are arrayed in a two-dimensional (2D) M×N pattern, may have M rows and N columns. The pixel array 310 may include a plurality of photosensitive elements (e.g., photodiodes or pinned photodiodes). The pixel array 310 may detect light using the plurality of photosensitive elements and convert the light into an analog electrical signal to generate an image signal. The operation of exposing a plurality of photosensitive elements to light may be performed by a shutter.

The row-driver 320 may drive the pixel array 310 for each row. For example, the row-driver 320 may output transmission control signals to the transmission transistors of the plurality of pixels 311 to 319 in the pixel array 310, and reset control signals to control reset transistors or reset selection control signals to control selection transistors to the pixel array 310. The row-driver 320 may determine a row to be read out.

The column-readout circuit 330 may receive analog electrical signals generated by the pixel array 310. For example, the column-readout circuit 330 may receive an analog electrical signal from a column line selected among the plurality of columns constituting the pixel array 310. The column-readout circuit 330 may include an analog-digital converter (ADC) 331 that may convert the analog electrical signal received from the selected column line into pixel data (or a digital signal) and output the pixel data. The column-readout circuit 330 receiving an analog electrical signal from the pixel array 310, converting the received analog electrical signal into pixel data using the ADC 331, and outputting the pixel data may be referred to as read-out. The column-readout circuit 330 and the ADC 331 may determine a column to be read out.

The column-readout circuit 330 of the image sensor 300 may include a plurality of ADCs 331. Each of the plurality of ADCs 331 may be connected in parallel with a respective one of the plurality of photodiodes in the pixel array 310, and analog electrical signals simultaneously received from the plurality of photodiodes may be converted into pixel data based on the parallel structure.

The controller 340 may obtain an image frame based on the pixel data received from the column-readout circuit 330. The controller 340 may output the image frame through the interface 360 to an external circuit 370. The controller 340 may generate transmission control signals to control the transmission transistors of the plurality of pixels 311 to 319, reset control signals to control reset transistors or reset selection control signals to control selection transistors, and provide the generated signals to the row-driver 320. The controller 340 may generate a selection control signal to select at least one column line among the plurality of column lines constituting the pixel array 310 and provide the generated signal to the column-readout circuit 330. For example, the column-readout circuit 330 may enable some of the plurality of column lines and disable the other column lines based on selection control signals provided from the controller 340.

For example, the controller 340 may obtain information about a first ROI from an external circuit 370. The controller 340 may receive information about the first ROI from the external circuit 370. The first ROI may be a first plurality of pixels among pixels 311 to 319. The controller 340 may control the row-driver 320 to drive the row corresponding to the first plurality of pixels and may control the column-readout circuit 330 to perform read-out from the column corresponding to the first plurality of pixels. Thus, an image frame corresponding to the first ROI may be obtained. Upon obtaining information about the changed ROI (e.g., the second ROI), the controller 340 may control the row-driver 320 to drive the row corresponding to the second plurality of pixels, and may control the column-readout circuit 330 to perform read-out from the column corresponding to the second plurality of pixels.

The controller 340 may be a component separate from a CPU or AP, but may be implemented as a processor (e.g., 120 or 260 of FIG. 1) including a CPU or an AP or a kind of block or module. When the controller 340 is implemented as a block, the controller 340 may include a subtractor for detecting a difference between, for example, images, or a comparator for comparing images. The controller 340 may downsize read-out images and compare the plurality of downsized images to detect differences between the images.

The memory 350 may include a volatile and/or non-volatile memory. The memory 350 is a storage device inside the image sensor 300. The memory 350 may include a buffer memory. The memory 350 may temporarily store digital signals output from the column-readout circuit 330 or the controller 340. For example, the memory 350 may include at least one image frame obtained based on light received by the pixel array 310. The memory 350 may store at least one digital signal received from the external circuit 370 through the interface 360.

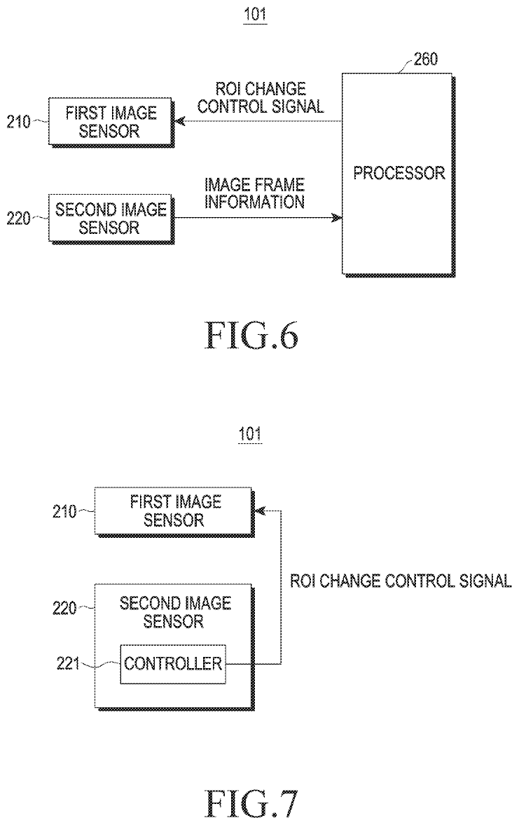

The memory 350 may store at least one image frame read out at a predetermined frame rate (e.g., 30 fps or 60 fps) from the column-readout circuit 330. The controller 340 may transfer at least one image frame stored in the memory 350 to the external circuit 370 via the interface 360. For example, when the image sensor 300 is the second image sensor 220 of the electronic device 101, the external circuit 370 may be the processor 260 of the electronic device 101. The processor 260 may obtain information about the ROI of the first image sensor 210 based on the image frame received from the second image sensor 220 and transfer the obtained ROI information to the first image sensor 210, which is described in greater detail below with reference to FIG. 6.

The controller 340 may transfer the control signal obtained based on at least one image frame stored in the memory 350 to the external circuit 370 via the interface 360. For example, when the image sensor 300 is the second image sensor 220 of the electronic device 101, the external circuit 370 receiving the information from the image sensor 300 may be the first image sensor 210 of the electronic device 101. The controller 340 may obtain information about the ROI of the first image sensor 210 based on the image frame stored in the memory 350 and transfer the obtained ROI information to the first image sensor 210, which is described in greater detail below with reference to FIG. 7.

The interface 360 may include, for example, the input/output interface 150 or the communication interface 170. The interface 360 may connect components of the image sensor 300, such as, for example, the controller 340 or the memory 350, with the external circuit 370 in a wireless or wired scheme. For example, the interface 360 may deliver at least one image frame stored in the memory 350 of the image sensor 300 to the external circuit 370, such as, for example, the memory 130 or 230 of the electronic device 101. The interface 360 may also deliver control signals from the processor 120 or 260 of the electronic device 101 to the controller 340 of the image sensor 300.

The image sensor 300 may communicate with the external circuit 370 through the interface 360 in a serial communication scheme. For example, the memory 350 of the image sensor 300 may communicate with the processor 120 or 260 of the electronic device 101 in an inter-integrated circuit (I²C) scheme. Without limitations thereto, the memory 350 of the image sensor 300 may communicate with the processor 120 or 260 of the electronic device 101 in a serial programming interface (SPI) or improved inter-integrated circuit (I³C) scheme.

The image sensor 300 may connect with the external circuit 370 through the interface 360, such as, for example, as defined as per the mobile industry processor interface (MIPI) protocol. For example, the memory 350 of the image sensor 300 may communicate with the processor 120 or 260 of the electronic device 101 as per the interface defined in the MIPI protocol. The interface 360 (e.g., the interface defined as per the MIPI protocol) may deliver pixel data corresponding to the image frames stored in the memory 350 to the external circuit 370 at the cycle of 1/120 seconds.

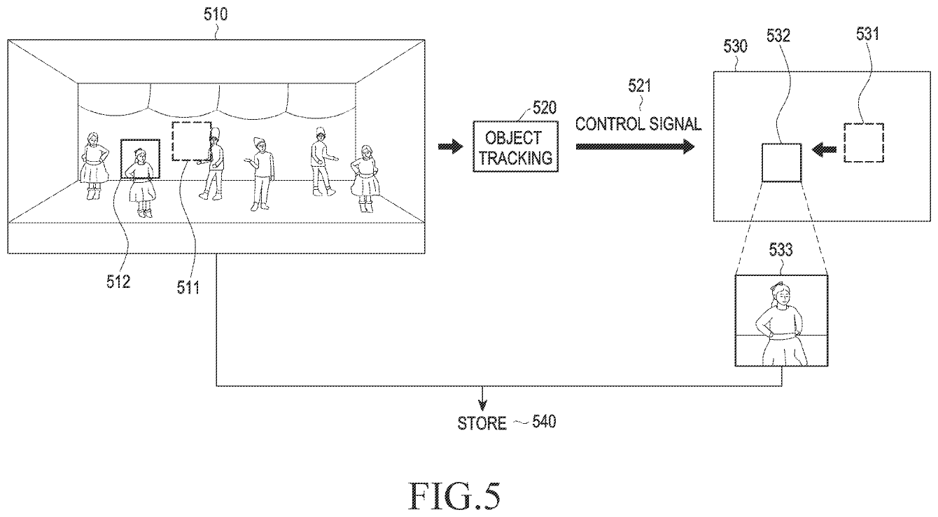

The controller 340 may control the read-out time and shutter time of some pixels among the pixels 311 to 319 included in the pixel array 310. For example, in a case where the image sensor 300 is the first image sensor 210 of the electronic device 101, when a control signal for changing the first ROI to the second ROI while the first plurality of pixels corresponding to the first ROI among the pixels 311 to 319 are exposed, the controller 340 may start to read out the first plurality of pixels and then start to expose the second plurality of pixels corresponding to the second ROI. In this case, the control signal for changing the first ROI to the second ROI may be obtained based on the image frame obtained from the second image sensor 220, which is described in greater detail below with reference to FIG. 5.

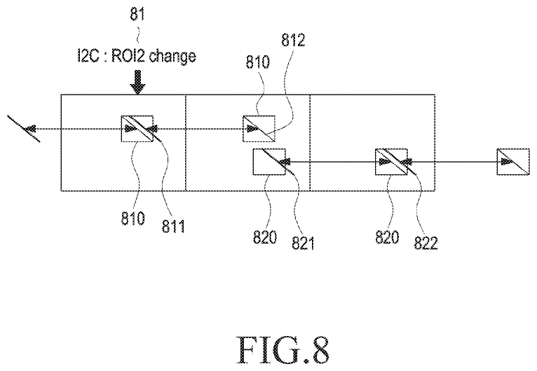

As described above, as the exposure of the second plurality of pixels begins simultaneously with starting to read out the first plurality of pixels, the output interval between the first image frame for the first ROI and the second image frame for the second ROI continuous from the first image frame may remain constant, which is described in greater detail below with reference to FIG. 8.

All or some of the above-described components 310 to 360 may be included in the image sensor 300 as necessary, and each component may be configured in a single unit or multiple units. The frame rates (e.g., 30 fps or 60 fps) used in the above-described embodiments may be varied depending on the settings of the electronic device or the performance of the interface.

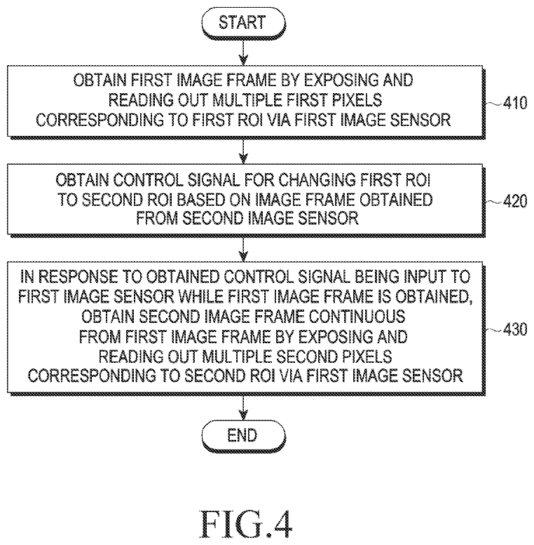

FIG. 4 is a flowchart illustrating operations of an electronic device performing a zoom function, according to an embodiment.

The electronic device 101 (e.g., the first image sensor 210) obtains a first image frame by exposing and reading out a first plurality of pixels corresponding to a first ROI, in operation 410. In this case, the first image sensor 210 may sequentially expose the row including the first plurality of pixels corresponding to the first ROI by a rolling shutter method, and read out only the first plurality of pixels corresponding to the first ROI. Alternatively, the first image sensor 210 may read out the entire row including the first plurality of pixels corresponding to the first ROI, and then obtain only the image frame corresponding to the first ROI via image processing.

In operation 420, the electronic device 101 (e.g., the second image sensor 220 or the processor 260) obtains a control signal for changing the first ROI to the second ROI based on the image frame obtained from the second image sensor 220. For example, when the position or size of the object region included in the image frame obtained from the second image sensor 220 is changed, the electronic device 101 may obtain information about the position or size of the changed object region and obtain a control signal for changing the first ROI to the second ROI based on the information about the position or size of the changed object region. The control signal may be obtained by the processor 260 or the second image sensor 220. The first image sensor 210 may obtain the control signal from the processor 260 or from the second image sensor 220.

Although it is described above that the control signal for changing the first ROI to the second ROI is obtained via object tracking in the image frame obtained from the second image sensor 220, the ROI may be changed by the user's control command entry, according to another embodiment.

In operation 430, when the obtained control signal is input to the first image sensor 210 while the first image frame is obtained, the electronic device 101 obtains the second image frame continuous from the first image frame by exposing and reading out the second plurality of pixels corresponding to the second ROI via the first image sensor 210. For example, when the obtained control signal is input to the first image sensor 210 while the first plurality of pixels are exposed, the first image sensor 210 may start to read out the first plurality of pixels corresponding to the first ROI and then start to expose the second plurality of pixels corresponding to the second ROI. For example, when the obtained control signal is input to the first image sensor 210 while the first plurality of pixels are exposed, it may be preferable to simultaneously perform the start of the read-out of the first plurality of pixels corresponding to the first ROI and the start of the exposure of the second plurality of pixels corresponding to the second ROI. However, an inevitable delay may intervene between the start time of the read-out of the first plurality of pixels and the start time of the exposure of the second plurality of pixels. As such, since the exposure of the second plurality of pixels starts as the read-out of the first plurality of pixels starts, although the region where the pixel signal is to be read out is changed from the first ROI to the second ROI, the output interval between the image frames may remain constant.

FIG. 5 is a diagram illustrating operations of an electronic device performing a zoom function using a plurality of image sensors, according to an embodiment.

The first image sensor 210 may obtain the first image frame by exposing and reading out the first plurality of pixels 531 corresponding to the first ROI among the plurality of pixels 530 of the first image sensor 210. For example, the first ROI may correspond to a region 511 including an object of interest in the image frame 510 obtained by the second image sensor 220.

The electronic device 101 may identify the first object region 511 including the object in the image frame 510 from the plurality of pixels of the second image sensor 220. The electronic device 101 may track 520 the object in the obtained image frame 510. Here, “track 520 the object” may refer to identifying a change in at least one of the position and size of the region including the object of interest in the continuous image frames.

For example, as shown in FIG. 5, as the object moves in the continuous image frames, the first object region 511 in the prior image frame may be changed to the second object region 512 in the current image frame 510. In this case, the electronic device 101 may obtain at least one of the position information and size information about the second object region 512. The electronic device 101 may obtain a control signal 521 for changing the ROI of the first image sensor 210, based on at least one of the position information and size information about the obtained second object region 512. The electronic device 101 may input the control signal 521 for changing the ROI to the first image sensor 210. As described above, when object tracking 520 is performed by the processor 120, the processor 120 may transfer the control signal 521 to the first image sensor 210. When object tracking 520 is performed by the second image sensor 220, the control signal 521 may be transferred from the second image sensor 220 to the first image sensor 210 directly or via the processor 120.

As shown in FIG. 6, object tracking 520 and obtaining the control signal 521 may be performed by the processor 260 of the electronic device 101. For example, the second image sensor 220 transfers the obtained image frame information to the processor 260. The processor 260 identifies whether at least one of the position and size of the region including the object is changed based on the image frame information obtained by the second image sensor 220. When at least one of the position and size of the region including the object is changed, the processor 260 obtains a control signal for changing the ROI of the first image sensor 210 based on at least one of the changed position and size information, and transfers the obtained ROI change control signal to the first image sensor 210. As described above, as a control signal for changing ROIs is obtained via the processor 260 which has high data processing capability, it is possible to more precisely track a change in the position and size of the object-containing region.

Alternatively, as shown in FIG. 7, object tracking 520 and obtaining the control signal 521 may be performed by the second image sensor 220 of the electronic device 101. For example, the second image sensor 220 includes a controller 221 (e.g., the controller 340 of FIG. 3), and the controller 221 identifies whether at least one of the position and size of the object-containing region in the image frame obtained from the second image sensor 220 is changed. When at least one of the position and size of the region including the object is changed, the controller 221 obtains a control signal for changing the ROI of the first image sensor 210 based on at least one of the changed position and size information and transfer the obtained ROI change control signal to the first image sensor 210. As such, it is possible to reduce resource consumption by generating a control signal for changing ROIs without intervention of the processor 260.

Referring back to FIG. 5, when a control signal 521 for changing the first ROI to the second ROI is input while the first image frame is obtained using the first plurality of pixels 531 corresponding to the first ROI, among the plurality of pixels 530 of the first image sensor 210, the electronic device 101 may obtain a second image frame 533 continuous from the first image frame by exposing and reading out a second plurality of pixels 532 corresponding to the second ROI among the plurality of pixels 530. For example, when the control signal 521 for changing the first ROI to the second ROI is input while the first plurality of pixels 531 among the plurality of pixels 530 of the first image sensor 210 are exposed, the electronic device 101 may start to read out the first plurality of pixels 531 while simultaneously starting to expose the second plurality of pixels 532. For example, the electronic device 101 may start to read out the first plurality of pixels 531 and, after an inevitable delay, start to expose the second plurality of pixels 532, which is described in greater detail below with reference to FIG. 8.

The electronic device 101 may obtain the image frame 533 corresponding to the second ROI by exposing and reading out the second plurality of pixels 532. The electronic device 101 may store 540 the image frame 511 obtained from the second image sensor 220 and the image frame 533 obtained from the first image sensor 210 in the memory 230. The angle of view of the image frame 511 obtained from the second image sensor 220 may be larger than the angle of view of the image frame 533 obtained from the first image sensor 210.

FIG. 8 is a block diagram illustrating operations of an image sensor when a control signal for changing the ROI is input, according to an embodiment.

An image sensor (e.g., the first image sensor 210 of FIG. 2 or the controller 340 of FIG. 3) may start (shutter) exposure 811 of a first plurality of pixels 810 corresponding to a first ROI among a plurality of pixels. The image sensor may obtain a first image frame by exposing and then reading out 812 the first plurality of pixels 810. The slope of the line indicating the start of the exposure 811 in FIG. 8 denotes the time when the first plurality of pixels 810 are exposed row-by-row and may mean the speed of shutter. The slope of the line indicating the start of the read-out 812 in FIG. 8 denotes the time when the first plurality of pixels 810 are read out row-by-row and may mean the speed of read-out.

As shown in FIG. 8, when a control signal 81 for changing the ROI is input to the image sensor after the exposure 811 of the first plurality of pixels 810 starts, the image sensor may start to expose 821 the second plurality of pixels 820 corresponding to the second ROI, simultaneously with or after the start of the read-out 812 of the first plurality of pixels 810, based on the input control signal 81. For example, the control signal 81 may be an I²C-based signal.

The control signal for changing the ROI may include coordinate information about at least two of the second plurality of pixels 820 corresponding to the second ROI (e.g., the coordinates of the two diagonal ones of the four vertices or the coordinates of the center and one vertex) or coordinate information about one of the second plurality of pixels 820 and size information about the second ROI. The control signal for changing the ROI may include variations in position and variations in size, based on information about the first ROI.

The image sensor may obtain the second image frame continuous from the first image frame by exposing and then reading out 822 the second plurality of pixels 820.

As described above, since the exposure of the second plurality of pixels 820 corresponding to the second ROI starts at the time of reading out the first plurality of pixels 810 corresponding to the first ROI as the control signal for changing the first ROI to the second ROI is input to the image sensor while the first image frame corresponding to the first ROI is obtained, although the region to be read out is changed, the output interval between the first image frame and the second image frame may remain constant while the maximum exposure is secured.

The control signal 81 for changing the ROI input to the image sensor may be obtained based on the image frame obtained from a different image sensor as shown in FIGS. 4 to 7. However, without limitations thereto, the electronic device 101 may receive a control signal for changing the ROI from an external device of the electronic device 101, obtain a control signal for changing the ROI in the electronic device 101, based on object movement information received from an external device, or obtain a control signal for changing the ROI, based on object movement information obtained via a sensor other than the image sensors equipped in the electronic device 101.

FIG. 9 is a diagram illustrating a read-out operation of an electronic device, according to an embodiment.

An image sensor may expose pixels in a rolling shutter fashion. For example, to obtain an image frame of an ROI 910, the image sensor may sequentially expose, row-by-row, the pixels of a row 920 including the ROI, among the plurality of pixels included in the image sensor.

The image sensor may store the image frame, obtained by exposing and reading out the pixels of the row 920 including the ROI 910, in a memory 350 and image-process the image frame stored in the memory 350 under the control of the processor 120 or 260 of the electronic device 101, thereby obtaining the image frame corresponding to the ROI 910.

Alternatively, the image sensor may obtain the image frame corresponding to the ROI 910 by image-processing the image frame obtained by exposing and reading out the pixels of the row 920 including the ROI 910 and store the image frame corresponding to the ROI 910 in the memory 350.

As described above, only the pixels of the row including the ROI among the plurality of pixels included in the image sensor are exposed and read out. This leads to a reduction in the power consumption of the image sensor and the consumption of the memory 350, as well as a reduction in the power consumption of the electronic device and the consumption of the memory.

FIG. 10 is a diagram illustrating a read-out operation of an electronic device considering correction, according to an embodiment.

The electronic device 101 (e.g., the processor 120 or 260) may perform image stabilization on the image frame obtained from an image sensor 210 or the controller 340 and store the corrected image frame in the memory 130 or 230. For example, referring to FIG. 10, the image sensor includes pixels of an ROI 1010 in a desired size and may store, in the memory 350, an image frame obtained by exposing and reading out the pixels of a row 1020 which is broader than the row of the ROI 1010. Image stabilization may be performed on the image frame stored in the memory 350 under the control of the processor 120 or 260 of the electronic device 101, thereby obtaining an image frame corresponding to the ROI 1010. For example, the image stabilization may be video digital image stabilization (VDIS). The electronic device 101 may obtain the image-stabilized image frame by cropping a partial area of the pixel values broader than the image frame.

It is possible to obtain an image frame in a constant size even when image stabilization is performed.

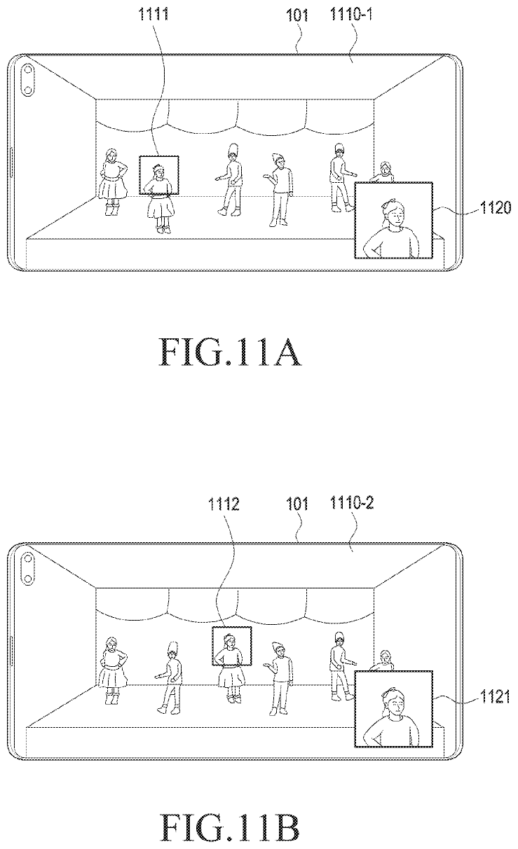

FIGS. 11A and 11B are diagrams illustrating operations of an electronic device when the ROI is changed as an obtained image is repositioned, according to an embodiment.

Referring to FIG. 11A, the electronic device 101 displays a first image frame 1110-1 obtained from the second image sensor 220, which has a broader angle of view, on the entire screen and a first image frame 1120 obtained from the first image sensor 210, which has a narrower angle of view, on a portion of the screen. For example, the first image frame 1120 obtained from the first image sensor 210 may correspond to an object region 1111 included in the first image frame 1110-1 obtained from the second image sensor 220. Although FIG. 11A illustrates the two image frames in a picture-in-picture (PIP) fashion, the screen of the electronic device 101 may be split into two areas for individually displaying the image frames, as an alternative.

As shown in FIG. 11B, as video plays, a second image frame 1110-2 obtained from the second image sensor 220 is displayed. When an object region 1112 is repositioned in the second image frame 1110-2 obtained from the second image sensor 220, the electronic device 101 obtains a second image frame 1121 from the first image sensor 210 based on the position information about the changed object region 1112 and display the same. For example, the electronic device 101 may identify whether the object region is repositioned via object recognition technology. The operation of obtaining the second image frame 1121 from the first image sensor 210 has been described above in connection with FIGS. 4 to 8.

As described above, an image frame with a narrower angle of view, including the object, is obtained by tracking the movement of the object and an image frame with a broader angle of view. Thus, the user may be given images which allow the user to feel new.

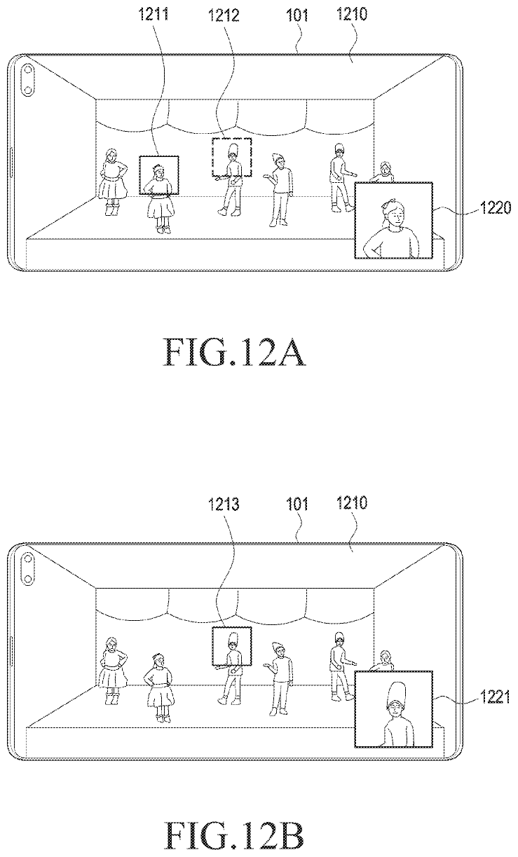

FIGS. 12A and 12B are diagrams illustrating operations of an electronic device when the ROI is changed by a user's selection, according to an embodiment.

Referring to FIG. 12A, the electronic device 101 displays an image frame 1210 obtained from the second image sensor 220, which has a broader angle of view, on the entire screen and a first image frame 1220 obtained from the first image sensor 210, which has a narrower angle of view, on a portion of the screen. For example, the first image frame 1220 obtained from the first image sensor 210 may correspond to an object region 1211 included in the image frame 1210 obtained from the second image sensor 220. Although FIG. 12A illustrates the two image frames in a picture-in-picture (PIP) fashion, the screen of the electronic device 101 may be split into two areas for individually displaying the image frames, as an alternative.

When the user inputs a control command to change the first object region 1211 to a second object region 1212, the electronic device 101 obtains a second image frame 1221 from the first image sensor 210 based on the position information about a second object region 1213 and display the same, as shown in FIG. 12B. The operation of obtaining the second image frame 1221 from the first image sensor 210 has been described above in connection with FIGS. 4 to 8.

As described above, as the user inputs a control command to change the object region from the image frame with a broader angle of view, the user may obtain an image frame with a narrower angle of view, which includes the object of interest.

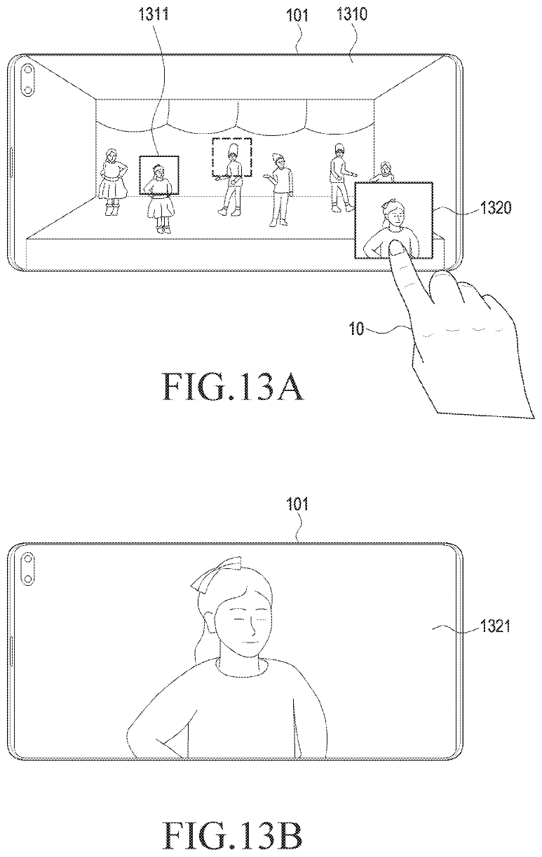

FIGS. 13A and 13B are diagrams illustrating operations of an electronic device when a user selects a zoomed image, according to an embodiment.

Referring to FIG. 13A, the electronic device 101 displays an image frame 1310 obtained from the second image sensor 220, which has a broader angle of view, on the entire screen and an image frame 1320 obtained from the first image sensor 210, which has a narrower angle of view, on a portion of the screen. For example, the image frame 1320 obtained from the first image sensor 210 may correspond to an object region 1311 included in the image frame 1310 obtained from the second image sensor 220. Although FIG. 13A illustrates the two image frames in a picture-in-picture (PIP) fashion, the screen of the electronic device 101 may be split into two areas for individually displaying the image frames, as an alternative.

When the user inputs a control command to select the image frame 1320 obtained from the first image sensor 210, the electronic device 101 displays an image frame 1321 in the size of the entire screen of the electronic device 101 corresponding to the selected image frame 1320, as shown in FIG. 13B. Thus, the user may view only images including the object of interest.

The electronic device 101 according to various embodiments may be one of various types of electronic devices. The electronic devices may include, for example, a portable communication device (e.g., a smart phone, tablet PC, or e-book reader), a computer device, a portable multimedia device, a portable medical device, a camera, a wearable device, or a home appliance. According to an embodiment of the disclosure, the electronic device is not limited to the above-listed embodiments.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

As is apparent from the foregoing description, according to an embodiment of the disclosure, a pixel included in a specific area of an image sensor is exposed and read out to obtain an image frame. Thus, the power and resource consumption of the electronic device may be reduced.

According to an embodiment of the disclosure, although the position and size of a specific area are changed as the object moves, image frames may be output at the same intervals.

According to an embodiment of the disclosure, a plurality of images with different fields of view (FOVs) may simultaneously be obtained. Thus, the user may be given a new experience.

While the disclosure has been shown and described with reference to certain embodiments thereof, it will be understood by those skilled in the art that various changes in form and detail may be made therein without departing from the spirit and scope of the disclosure as defined by the appended claims and their equivalents.

What is claimed is:

1. An electronic device, comprising:
a first image sensor; and
a second image sensor,
wherein the first image sensor is configured to:
obtain a first image frame by exposing and reading out a first plurality of pixels corresponding to a first region of interest (ROI); and
in response to a control signal for changing the first ROI to a second ROI, obtain a second image frame continuous from the first image frame by exposing and reading out a second plurality of pixels corresponding to the second ROI, wherein the second ROI is obtained based on an image frame obtained from the second image sensor, and the control signal is input while the first image frame is being obtained.

2. The electronic device of claim 1, wherein:
the first ROI corresponds to a first region including a first object of an image frame obtained from the second image sensor; and
the second image sensor is configured to:
in response to at least one of a position and a size of the first region being changed, obtain the control signal for changing the first ROI to the second ROI corresponding to the changed first region, based on at least one of position information and size information about the changed first region; and
input the control signal to the first image sensor.

3. The electronic device of claim 1, further comprising a processor operatively connected with the first image sensor and the second image sensor, wherein:
the first ROI corresponds to a first region including a first object of an image frame obtained from the second image sensor; and
the processor is configured to:
in response to at least one of a position and a size of the first region being changed, obtain the control signal for changing the first ROI to the second ROI corresponding to the changed first region, based on at least one of position information and size information about the changed first region; and
input the control signal to the first image sensor.

4. The electronic device of claim 1, wherein the first image sensor is configured to, in response to the control signal being input to the first image sensor while the first plurality of pixels are exposed, start to read out the first plurality of pixels corresponding to the first ROI and then start to expose the second plurality of pixels corresponding to the second ROI.

5. The electronic device of claim 1, further comprising a memory, wherein the first image frame obtained from the first image sensor, the second image frame, and the image frame obtained from the second image sensor are stored in the memory.

6. The electronic device of claim 5, further comprising a processor operatively connected with the memory, wherein the processor is configured to:
perform image stabilization on the image frame obtained from the first image sensor and store a corrected ROI image frame in the memory, wherein a size of the corrected ROI image frame is smaller than a size of at least one of the first ROI and the second ROI.

7. The electronic device of claim 1, wherein an angle of view of the image frame obtained from the second image sensor is larger than an angle of view of the image frame obtained from the first image sensor.

8. The electronic device of claim 1, wherein the control signal includes coordinate information about at least two of the second plurality of pixels corresponding to the second ROI, or coordinate information about at least one of the second plurality of pixels, and size information about the second ROI.

9. A method of controlling an electronic device, the method comprising:
obtaining a first image frame by exposing and reading out a first plurality of pixels corresponding to a first ROI via a first image sensor;
while the first image frame is being obtained, obtaining a control signal for changing the first ROI to a second ROI based on an image frame obtained from the second image sensor; and
in response to the obtained control signal, obtaining a second image frame continuous from the first image frame by exposing and reading out a second plurality of pixels corresponding to the second ROI via the first image sensor.

10. The method of claim 9, wherein:
the first ROI corresponds to a first region including a first object of an image frame obtained from the second image sensor; and
obtaining the control signal includes, in response to at least one of a position and a size of the first region being changed, obtaining, by the second image sensor, the control signal for changing the first ROI to the second ROI corresponding to the changed first region, based on at least one of position information and size information about the changed first region.

11. The method of claim 9, wherein:
the first ROI corresponds to a first region including a first object of an image frame obtained from the second image sensor; and
obtaining the control signal includes, in response to at least one of a position and a size of the first region being changed, receiving, by a processor, at least one of position information and size information about the changed first region and obtaining a control signal for changing the first ROI to the second ROI corresponding to the changed first region based on at least one of the position information and size information about the changed first region.

12. The method of claim 9, wherein obtaining the second image frame continuous from the first image frame includes, in response to the control signal being input to the first image sensor while the first plurality of pixels are exposed, starting to read out, by the first image sensor, the first plurality of pixels corresponding to the first ROI and then starting to expose the second plurality of pixels corresponding to the second ROI.

13. The method of claim 9, further comprising storing the image frame obtained from the first image sensor and the image frame obtained from the second image sensor in a memory.

14. The method of claim 13, further comprising:
performing image stabilization on the image frame obtained from the first image sensor; and
storing a corrected ROI image frame in the memory, wherein a size of the corrected ROI image frame is smaller than a size of at least one of the first ROI and the second ROI.

15. The method of claim 9, wherein an angle of view of the image frame obtained from the second image sensor is larger than an angle of view of the image frame obtained from the first image sensor.

16. The method of claim 9, wherein the control signal includes coordinate information about at least two of the second plurality of pixels corresponding to the second ROI, or coordinate information about at least one of the second plurality of pixels, and size information about the second ROI.

17. An image sensor, comprising;
a plurality of pixels; and
a controller configured to:
obtain a first image frame by exposing and reading out a first plurality of pixels corresponding to a first ROI among the plurality of pixels;
in response to a control signal for changing the first ROI to a second ROI, obtain a second image frame continuous from the first image frame by exposing and reading out a second plurality of pixels corresponding to the second ROI, wherein the control signal is input while the first image frame is being obtained.

18. The image sensor of claim 17, wherein, in response to the control signal, the controller is further configured to start to read out the first plurality of pixels corresponding to the first ROI and then start to expose the second plurality of pixels corresponding to the second ROI.
